(19) United States
(12) Patent Application Publication
(10) Pub. No.: US 2013/0106294 A1
(43) Pub. Date: May 2, 2013

(54) ORGANIC LIGHT EMITTING DIODES IN LIGHT FIXTURES

(71) Applicants: Stefan Rakuff, Clifton Park, NY (US); Joseph John Shiang, Niskayuna, NY (US)

(72) Inventors: Stefan Rakuff, Clifton Park, NY (US); Joseph John Shiang, Niskayuna, NY (US)

(73) Assignee: General Electric Company, Schenectady, NY (US)

(21) Appl. No.: 13/285,980

(22) Filed: Oct. 31, 2011

(51) Int. Cl. H05B 37/02; H05B 37/00; F21V 7/00

(52) U.S. Cl. 315/154; 362/296.01; 315/312; 315/161; 315/159; 315/169.3

(57) ABSTRACT

One or more embodiments include a light module having a reflective light source having one or more organic light emitting diode (OLED) elements. The reflective light source reflects light from other light sources and/or emits light when powered. The reflective light source includes control circuitry which senses the amount of light reflected or emitted and powers the light source based on an intensity of the sensed reflected or emitted light. In one embodiment, the reflective light source is used with a primary light source in the light module which may be in the form of a fluorescent light, direct sunlight, or diffuse daylight. The reflective light source reflects portions of light from the primary light source while the control circuitry senses an interruption or decrease in the power supplied to the primary light source and powers the secondary light source from an uninterruptible power source such as a battery.

### BACKGROUND

Optoelectronic devices such as organic light emitting diodes (OLEDs) are being increasingly employed for lighting and display applications. The OLED includes a stack of thin organic layers sandwiched between two charged electrodes (anode and cathode). The organic layers may include a hole injection layer, a hole transport layer, an emissive layer, an electron transport layer, and an electron injection layer. Upon application of an appropriate voltage to the OLED lighting device, the injected positive and negative charges recombine in the emissive layer to produce light.

OLED devices have been increasingly employed for lighting applications in part because an OLED device may emit a similar amount of luminescence compared to an incandescent light device with significantly less energy. Due to the efficient nature of typical OLED devices, an OLED device may by powered by a relatively low voltage or low current battery for a relatively long period of operation. Furthermore, OLED devices may be fabricated on either a rigid substrate, such as glass, or on a flexible substrate such as polyethylene naphthalate (PEN) or polyethylene terephthalate (PET). Flexible substrates in particular may be efficiently produced using high-volume roll-to-roll production techniques and may result in a more flexible OLED device. Generally, flexible polymers used as substrates for OLED devices are coated with barrier materials which prevent and/or slow the ingress of water vapor, oxygen, and other environmental agents which may degrade the organic materials in an OLED device, resulting in efficiency loss and visual defects.

While OLED devices may be advantageously used in various lighting applications, different types of light sources may sometimes be preferred. For example, existing light fixtures may be configured to power a fluorescent light source, and the cost for rewiring a building and/or the light fixtures to power OLED devices may be higher than the immediate cost savings of converting to OLED devices. Furthermore, certain lighting characteristics from various types of light sources may be suitable for lighting different environments.

### BRIEF DESCRIPTION

In one embodiment, a light emitting module is provided. The light emitting module includes a reflective light source having one or more organic light emitting diode (OLED) devices. The reflective light source is configured to reflect light from a different light source and configured to emit light based on the light reflected from the different light source.

In another embodiment, a lighting system is provided. The lighting system includes a primary light source, a secondary light source, control circuitry, and a secondary power source. The secondary light source includes one or more organic light emitting diode (OLED) devices. The primary light source is configured to emit light when powered by a primary power supply. The control circuitry is configured to determine whether the primary light source is powered and power the secondary light source using the secondary power source when the primary light source is determined to not be powered.

Yet another embodiment involves a method of operating a light module. The method includes monitoring a primary light source in the light module to determine whether the primary light source is emitting light and whether the primary light source is switched to an on state. The method also includes activating a secondary light source in the light module when the primary light source is not emitting light while switched to the on state. The secondary light source comprises one or more organic light emitting diode (OLED) devices.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a side view of an organic light emitting diode (OLED) stack, in accordance with one embodiment of the present disclosure;

FIG. 2 depicts a perspective view of an OLED light module, in accordance with one embodiment of the present disclosure;

FIG. 3 depicts a cross-sectional side view of the OLED light module of FIG. 2, in accordance with one embodiment of the present disclosure;

FIG. 4 depicts a semi diagrammatical view of an OLED light module arranged to reflect light from an overhead window, in accordance with one embodiment of the present disclosure; and

FIG. 5 depicts a cross-sectional view of an interior enclosed space with OLED light modules arranged to reflect light from a wall window, in accordance with one embodiment of the present disclosure.

### DETAILED DESCRIPTION

Organic materials are becoming increasingly utilized in circuit and lighting area technology due to the low cost and high performance offered by organic electronic devices and optoelectronic devices. For example, optoelectronic devices such as organic light emitting diodes (OLEDs) may be employed for lighting and display applications. One or more embodiments of the present disclosure involve utilizing an OLED device having one or more OLEDs as a secondary light source in a light module. In some embodiments, the light module may include a primary light source including any suitable light source (e.g., linear fluorescent lights, compact fluorescent lights, incandescent lights, daylight, etc.) and a secondary light source including the OLED device.

In some embodiments, the OLED device may include reflective areas or surfaces and may be configured to reflect a portion of light illuminated by the primary light source, thereby increasing the amount of light emitted from the light module to a lit area (e.g., in a downward direction from a ceiling-mounted light module). For example, in some embodiments, the reflective area or surface on the OLED device may include an electrode of the OLED. Furthermore, the OLED device may be activated when illumination by the primary light source is interrupted. For example, an interruption of illumination from the primary light source may result from a power outage or an electrical or mechanical failure of the primary light source. As the OLED device may be relatively power efficient, the OLED device may provide illumination using an uninterruptible power supply, such as a battery, when the primary light source fails, such as due to lack of power. Therefore, the light module may provide light substantially continuously even if illumination from the primary light source is interrupted.

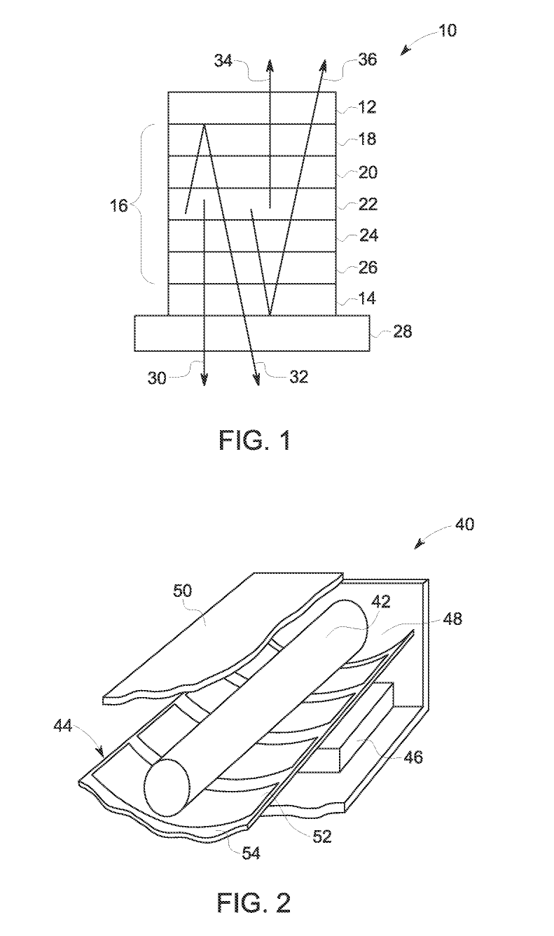

Referring to FIG. 1, the side view of an OLED stack 10 in an optoelectronic device is illustrated. The OLED stack 10 may represent a cross-sectional side view of a portion of the layers in a representative OLED device. The OLED stack 10 may include a top electrode (i.e., cathode) 12 and a bottom electrode (i.e., anode) 14 disposed over a substrate 28, with organic layers 16 disposed between the cathode 12 and the anode 14. In some embodiments, the organic layers 16 may include a hole injection layer 26 which may be disposed over the anode 14. A hole transport layer 24 may be disposed over the hole injection layer 26, and an emissive layer 22 may be disposed over the hole transport layer 24. An electron transport layer 20 may be disposed over the emissive layer 22, and an electron injection layer 18 may be disposed over the electron transport layer 20.

In some embodiments, the anode 14 may include a substantially transparent doped thin metal oxide film, such as indium tin oxide (ITO), tin oxide, indium oxide, zinc oxide, indium zinc oxide, zinc indium tin oxide, antimony oxide, and mixtures thereof. The thickness of the anode 14 may range from approximately 10 nm to 200 nm, though other thicknesses are also contemplated.

Examples of materials suitable for the hole injection layer 26 disposed over the anode 14 may include proton-doped (i.e., “p-doped”) conducting polymers, such as p-doped polythiophene or polyaniline, and p-doped organic semiconductors, such as tetrafluorotetracyanoquinodimethane (F4-TCQN), doped organic and polymeric semiconductors, and triarylamine-containing compounds and polymers.

The hole transport layer 24 disposed over the hole injection layer 26 may include, for example, triaryldiamines, tetraphenyldiamines, aromatic tertiary amines, hydrazone derivatives, carbazole derivatives, triazole derivatives, imidazole derivatives, oxadiazole derivatives including an amino group, polythiophenes, and like materials. Non-limiting examples of materials suitable for a hole transport layer 24 may include poly N-vinyl carbazole, and like materials.

The emissive layer 22 may include any electroluminescent organic materials that emit radiation in the visible spectrum upon electrical stimulation. In some embodiments, such materials may include electroluminescent organic materials which emit light in a determined wavelength range. For example, the electroluminescent organic materials in the emissive layer 22 may include small molecules, oligomers, polymers, copolymers, or a mixture thereof. For example, suitable electroluminescent organic materials 28 may include Tris(8-hydroxyquinolinato)aluminium (Alq3) and its derivatives; poly N-vinylcarbazole (PVK) and its derivatives; polyfluorene and its derivatives, such as polyalkylfluorene, for example poly-9,9-dihexylfluorene, polydioctylfluorene, or poly-9,9-bis-3,6-dioxaheptyl-fluorene-2,7-diyl; polypara-phenylene and its derivatives, such as poly-2-decyloxy-1,4-phenylene or poly-2,5-diheptyl-1,4-phenylene; polyp-phenylene vinylene and its derivatives, such as dialkoxy-substituted PPV and cyano-substituted PPV; polythiophene and its derivatives, such as poly-3-alkylthiophene, poly-4,4′-dialkyl-2,2′-bithiophene, poly-2,5-thienylene vinylene; polypyridine vinylene and its derivatives; polyquinoxaline and its derivatives; and polyquinoline and its derivatives. In one embodiment, a suitable electroluminescent material is poly-9,9-dioctylfluorenyl-2,7-diyl end capped with N,N-bis4-methylphenyl-4-aniline. Mixtures of these polymers or copolymers based on one or more of these polymers may be used. Other suitable materials may include polysilanes, or linear polymers having a silicon-backbone substituted with an alkyl and/or aryl side groups. Polysilanes are quasi one-dimensional materials with delocalized sigma-conjugated electrons along polymer backbone chains. Examples of polysilanes include poly di-n-butylsilane, poly di-n-pentylsilane, poly di-n-hexylsilane, polymethyl phenylsilane, and poly bis p-butyl phenylsilane.

The electron transport layer 20 disposed over the emissive layer 22 may include small molecules or low-to-intermediate molecular weight organic polymers, for example, organic polymers having weight average molecular weights of less than about 200,000 grams per mole as determined using polystyrene standards. Such polymers may include, for example, poly-3,4-ethylene dioxy thiophene (PDOT), polyaniline, poly-3,4-propylene dioxythiophene (PPropOT), polystyrene sulfonate (PSS), polyvinyl carbazole (PVK), and other like materials. The electron injection layer 18 disposed over the electron transport layer 20 may include, for example, sodium fluoride or potassium fluoride, or other like materials.

The cathode 12 may include a vapor-deposited metal layer having a thickness of approximately 100 nm to 1000 nm. The cathode 12 may include conductive, reflective materials such as aluminum, silver, indium, tin, zinc, other suitable metals, and combinations thereof. In some embodiments, the cathode 12 may also be relatively thin (e.g., about 30 nm) and may be transparent. The cathode 12 may be deposited over the electron injection layer 18 by, for example, physical vapor deposition, chemical vapor deposition, sputtering or liquid coating.

In some embodiments, the OLED stack 10 may also include different or additional non-emissive materials which may improve the performance or lifespan of the electroluminescent materials in the emissive layer 22. For example, in addition to the hole injection layer 26, the hole transport layer 24, the electron transport layer 20 and the electron injection layer 18, the stack 10 may also include layers such as a hole injection enhancement layer, an electron injection enhancement layer, getter materials, or any combinations thereof. Furthermore, in some embodiments, the layers of the OLED stack 10 may be arranged in different orders or in different combinations, and additional layers may be disposed between the layers illustrated in FIG. 1.

During operation of an optoelectronic device, a voltage may be applied across the OLED stack 10. The voltage may charge the anode 14 to a positive charge and the cathode 12 to a negative charge, and electrons may flow through the stack 10 from the negatively charged cathode 12 to the positively charged anode 14. More specifically, electrons may be withdrawn from the organic materials adjacent to the anode 14 and injected to the organic materials adjacent to the cathode 12. The process of withdrawing electrons from the anode-side organic materials may also be referred to as hole injection and hole transport, and the process of injecting the electrons to the cathode-side organic materials may also be referred to as electron transport and electron injection. During the process of hole and electron transport/injection, electrons are withdrawn from the hole injection layer 26, transported through the hole transport layer 24 and the electron transport layer 20, and injected to the electron injection layer 18. Electrostatic forces may combine the electrons and holes in the emissive layer 22 to form an excited bound state (i.e., an excitation) which upon de-excitation, emits radiation having frequencies in the visible region of the electromagnetic spectrum (e.g., visible light). The frequency of the emitted radiation and the colors and/or characteristics of visible light may vary in different embodiments depending on the properties of the particular materials used in the OLED stack 10.

In some embodiments, the visible light emitted by the emissive layer 22 may be transmitted (as indicated by the arrow 30) through the organic layers 24 and 26 and through the transparent anode 14 and substrate 28 and out of the stack 10. In such OLED configurations, referred to as bottom emission OLEDs, the light which travels from the emissive layer 22 may also travel through the organic layers 20 and 18. In some embodiments, the cathode 12 may be reflective, and the light which travels away from the substrate 28 may be reflected (as indicated by the arrow 32) by the reflective cathode 12 and transmitted out through the substrate 28 and out of the stack 10.

Furthermore, in some embodiments, the visible light emitted by the emissive layer 22 may be transmitted (as indicated by the arrow 34) through the organic layers 20 and 18 and through a transparent cathode 12 and out of the stack 10. In such OLED configurations, referred to as top emission OLEDs, light may also travel through organic layers 24 and 26 in such devices. The substrate 28 and/or the anode 14 may be reflective in some embodiments, or alternatively, the stack 10 may include an additional reflective layer, such that light that travels away from the cathode 12 in top emission OLEDs may be reflected (as indicated by the arrow 36) and transmitted out through the cathode 12 and out of the stack 10. The light transmitted out of the stack 10 may be perceived as visible light which may illuminate out of an optoelectronic device.

Generally, a bottom emission OLED may have an anode 14 that is transparent to light and a cathode 12 that is reflective to light to increase light extraction of the OLED device. A top emission OLED may have an anode 14 that is reflective to light to increase the light extraction out of the OLED device. Reflective electrodes (e.g., a reflective cathode 12 or a reflective anode 14) may be produced using a vapor deposition techniques (e.g., physical vapor deposition, chemical vapor deposition, sputtering or liquid coating), and the thickness of the layer may be between 10 nm to 1000 nm. Suitable metals may include, for example, aluminum, silver, indium, tin, zinc, or other suitable metals and combinations thereof which increase the reflectivity and electrical efficiency of the OLED device. In some embodiments, a reflective cathode 12 or a reflective anode 14 may have a mirror-like appearance.

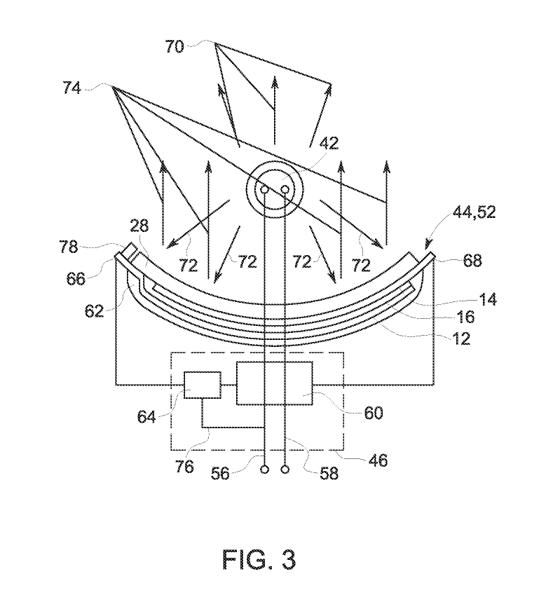

With the foregoing discussion of OLED devices and their operation in mind, one or more embodiments of the present disclosure involve utilizing a light-emissive OLED device having at least one reflective layer in a light module (e.g., a light fixture). One embodiment of a light module which utilizes an OLED device having a reflective layer as a secondary light source is illustrated in perspective view of FIG. 2, and FIG. 3 is a more detailed illustration of a cross-sectional side view of the embodiment illustrated in FIG. 2. As such, FIGS. 2 and 3 will be discussed concurrently.

The light module 40 may include a primary light source 42 (such as the depicted linear fluorescent lamp), a secondary light source 44 (here depicted as OLED devices), and a power supply and controller 46 which directs and/or supplies power to the primary light source 42 and/or the secondary light source 44. The secondary light source 44 may include a plurality of separate OLED substrates, a single OLED substrate with multiple OLED pixels, or a combination thereof. As illustrated in FIG. 2, the primary light source 42, the secondary light source 44, and the power supply and controller 46 may be substantially contained in a frame 48, and light may be emitted out of the light module 40 through a diffuser 50. It should be noted that for the purpose of more clearly depicting other components in the light module 40, a partial frame 48 is illustrated in FIG. 2, and the frame 48 is not illustrated in FIG. 3. However, in some embodiments, the frame 48 and/or diffuser 50 may substantially encompass the primary light source 42, secondary light source 44, and the power supply and controller 46.

In accordance with the present disclosure, the secondary light source 44 may be configured to reflect a portion of light from the primary light source 42 in a direction out of the light module 40, such as toward the diffuser 50. In some embodiments, a reflective layer of the secondary light source 44 may improve the efficacy of the light module 40 by reflecting the light from the primary light source 42 out of the light module 40. In some embodiments, the secondary light source 44 may also be configured to activate in response to an interruption in the operation of the primary light source 42. Furthermore, in some embodiments, the secondary light source 44 may include various configurations of OLED devices. For example, the OLED devices 52 may be arranged in one continuous sheet, or several separate OLED devices 52 may be arranged in the secondary light source 44, as illustrated in FIG. 2. In some embodiments, the secondary light source 44 may emit light in different colors. For example, the OLED devices 52 may include organic materials suitable for emitting red, green, blue, and/or white light, depending on the application of the light module 40. Alternatively, in some embodiments, the secondary light module 40 may include color filters to emit light in various colors.

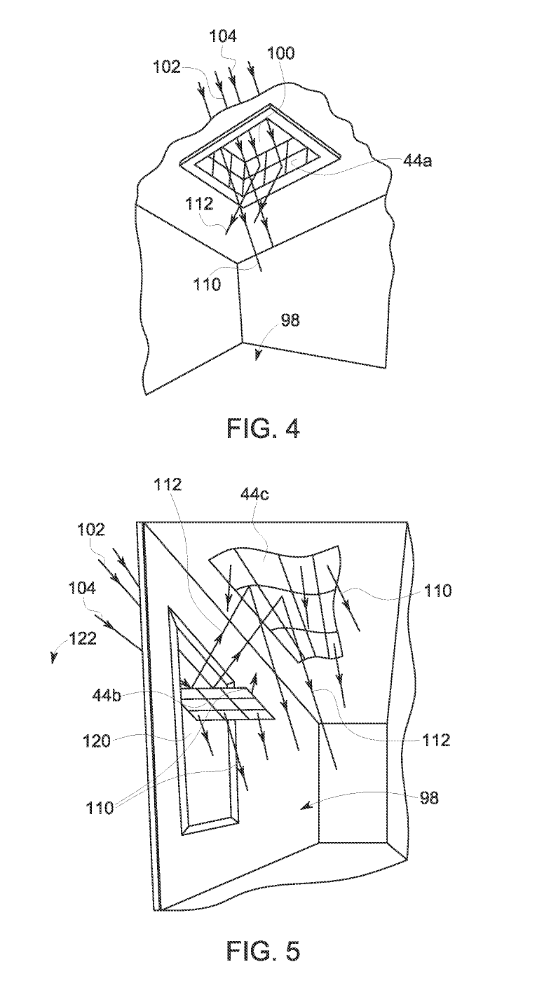

The primary light source 42 may include any suitable light source, such as linear fluorescent lamps, compact fluorescent lamps, incandescent light bulbs, etc. The primary light source 42 may also include daylight, as will be further discussed with respect to FIGS. 4 and 5. In some embodiments, the primary light source 42 may be powered by a power source such as a wall outlet. For example, as illustrated in FIG. 3, a first power supply lead 56 and a second power supply lead 58 may connect the primary light source 42 to an electrical power supply associated with a room or building. In some embodiments, the primary light source 42 may be switched on or off by, for example, a wall switch, and control circuitry 60 in the power supply and controller 46 may connect or disconnect the power supplied to the primary light source 42 through the power supply leads 56 and 58 based on the condition of the wall switch. In a normal operation mode (i.e., when the primary light source 42 is switched on and emitting light), the control circuitry 60 may control the supply of power from the power supply leads 56 and 58 to the primary light source 42. The control circuitry 60 may also charge an uninterruptible power supply 64 or maintain a maximum charge of the uninterruptible power supply 64, as will be discussed.

The secondary light source 44 may include one or more OLED devices 52, each having a configuration similar to the OLED stack 10 illustrated in FIG. 1. As illustrated in FIG. 3, the secondary light source 44 may include an OLED device 52 having a cathode 12, an anode 14, and one or more organic layers 16 disposed between the cathode 12 and anode 14. The OLED device 52 depicted in FIG. 3 may, in one implementation, be a bottom emissive OLED, as light generated in the organic layers 16 may travel in a direction out of the device 52 through the anode 14 and the substrate 28.

The cathode 12 may be encapsulated by a barrier layer 62 which may protect the OLED device 52 from degradation by water, oxygen, or other environmental reactants. The barrier layer 62 may include, for example, substantially impermeable material such as an insulator-coated metal foil.

The substrate 28 may include a transparent plastic coated with a conductive layer, such as metal oxide or a nano-array with conductive polymers. In some embodiments, the substrate 28 may be coated with barrier layers and/or light extraction films. For example, the substrate 28 may include barrier layers such as a graded structure which oscillates between organic rich and inorganic rich zones. The light extraction films may include surface-textured film or volumetric light scattering composites. For example, volumetric light scattering composites may include embedded particles (e.g., zirconia particles, phosphorescent scattering particles such as fluoro-chloro apatite or persistent luminescent materials such as SrAl₂O₄:Eu², Dy³, etc.) in a suitable host material (e.g., polymethyl methacrylate matrix).

In some embodiments, the substrate 28, as well as other layers in the device 52, may be substantially flexible, such that the secondary light source 44 may be arranged in an angle or arc. In some embodiments, the secondary light source 44 may be arranged in an angle or arc with respect to an axial direction of the primary light source 42. For example, the secondary light source 44 may be trough shaped and may have a parabolic cross section. The primary light source 42 may be placed near the position of the focal point of the parabola in some embodiments. Arranging the secondary light source in an angle or arc may increase the diffuse reflection of light emitted by the OLED devices 52, as well as portions of light emitted by the primary light source 42. In some embodiments, as the OLED devices 52 may be reflective, the OLED devices 52 may be angled or arced such that the diffuse reflection is at least 50% in the visible region. In some embodiments, the OLED devices 52 may be angled or arced such that the diffuse reflection is at least 80% in the visible region.

Furthermore, the substrate 28 may be coated with reflective materials. As depicted in FIG. 2, the substrate 28 may include an arrangement of OLED devices 52 in reflective areas 54. The reflective areas 54 may include areas of the reflective substrate 28 which do not have disposed OLED devices 52 (i.e., gaps of the substrate 28 between OLED devices 52). The reflective coating of the substrate 28 over the OLED devices 52 and the reflective areas 54 may reflect light which travels from the primary light source 42 out through the diffuser 50 of the light module 40. In some embodiments, the substrate 28 may have a reflectivity of approximately 70% or higher. In some embodiments, the reflective coating of the substrate 28 in portions of the substrate 28 over the OLED devices 52 may not significantly interfere with the transmission of light emitted by the OLED devices 52 out through the substrate 28.

Due to the reflectivity of the substrate 28, the secondary light source 44 may reflect a portion of light illuminated by the primary light source 42. For example, as illustrated in FIG. 3, the primary light source 42 may emit light 70 in a direction out of the light module 40 (e.g., towards a diffuser 50, FIG. 2). The primary light source 42 may also emit light 72 in a direction towards the secondary light source 44. In some embodiments, reflective elements (e.g., a reflective coating on the substrate 28 and/or a reflective, mirror-like cathode 12) on the secondary light source 44 may reflect light 74 away from the surface of the secondary light source 44, in a direction out of the light module 40. As such, the secondary light module 44 may increase the amount of light emitted out of the light module 40 towards a lit area (e.g., in a downward direction from a ceiling-mounted light module 40.

In some embodiments, the OLED devices 52 may be configured to activate (i.e., turn ‘on’ or emit light) in response to an interruption in the operation of the primary light source 42. For example, the control circuitry 60 may be suitable for detecting such an interruption of the primary light source 42 when the primary light source 42 is otherwise supposed to be active. An interruption of the primary light source 42 may refer to a situation where the primary light source 42 is not emitting light. In some embodiments, an interruption of the primary light source 42 may refer to a situation where the primary light source 42 is not emitting light while the primary light source is switched to an on state. For instance, such situations may occur if the primary light source 42 is turned on (e.g., switched on by a wall switch), but is not emitting light due to an interruption of the power supply (e.g., power outage). Interruptions of the primary light source 42 may also refer to electrical or mechanical failures of one or more components of the light module 40 (e.g., a broken primary light source 42, disconnected power supplies, etc.).

The control circuitry 60 may be connected to a sense wire 76 which is connected to a power supply lead 56 of the primary light source 42. The control circuitry 60 may sense whether power is supplied to the primary power source 42 through the sense wire 76. In some embodiments, other sensing mechanisms may be used. For example, the control circuitry 60 may include a light sensor 78 configured to sense whether light is or is not emitted by the primary light source 42. In some embodiments, the control circuitry 60 may receive an output signal of the light sensor 78 and determine whether the primary light source 42 is emitting light, at least based on the output signal of the light sensor 78. For example, in some instances, the primary light source 42 may be switched on and may be receiving power. However, due to a failure of the primary light source bulb, the primary light source 42 does not emit light. In such situations, the control circuitry 60 may determine that the primary light source 42 has been interrupted based on the switched state (i.e., on) of the primary light and the output of the light sensor 78 (i.e., not emitting light).

In response to sensing an interruption of the primary light source 42, the control circuitry 60 may control the activation of the secondary light source 44 by supplying power to the secondary light source 44 from an uninterruptable power supply 64. The uninterruptible power supply 64 may refer to any suitable power supply that is separate and distinct from the power supply that powers the primary light source 42. In some embodiments, the uninterruptible power supply 64 may be connected to one or more capacitors or batteries and may be connected to the secondary light source 44 at a cathode connection point 66 and an anode connection point 68. In response to a voltage driven through the OLED device 52 between the cathode and anode connection points 66 and 68, the organic layers 16 may emit light. Therefore, the light module 40 may provide light substantially continuously through the secondary light source 44 even if illumination from the primary light source 42 is interrupted.

In some embodiments, the control circuitry 60 may maintain a charge stored in the uninterruptible power supple 64 when the light module 40 is operating normally (i.e., the primary light source 42 is emitting light). The control circuitry 60 may also activate the uninterruptible power supple 64 when the control circuitry 60 senses an interruption of the primary light source 42. Furthermore, in some embodiments, the control circuitry 60 may meter the power supplied to the secondary light source 44. In some embodiments, the control circuitry 60 may include one or more power converters (e.g., AC-DC converter), integrated battery charging circuitry (e.g., bq24022, from Texas Instruments®), a lithium battery, and digital logic circuitry for enabling activation of the secondary light source 44. In some embodiments, the control circuitry 60 may include digital logic circuitry which measures the output of the integrated battery charging circuitry to detect the presence of a line input power, such that the secondary light source 44 may operate only when the primary light source 42 is not powered.

In some embodiments, the light that is emitted by the primary light source 42, emitted by the secondary light source 44, and/or reflected by the secondary light source 44 may travel out of the diffuser 50. The diffuser 50 may spread or scatter light traveling out of the light module 40. For example, spreading or scattering the light traveling out of the light module 40 may improve certain characteristics of the light.

In some embodiments, a light module 40 utilizing an OLED device with a reflective layer as a secondary light source 44 may be utilized to reflect direct sunlight or diffuse daylight to be emitted out of the light module. In such embodiments, the direct sunlight or the diffuse daylight may be the primary light source, and the OLED device having a reflective layer may be the secondary light source. As used herein, sunlight or daylight may refer to light sources such as light from the sun or any ambient light in an environment. In embodiments where the primary light source includes daylight, the secondary light source may be configured to reflect diffuse daylight and/or direct sunlight for purposes of daylighting. Daylighting may refer to applications in which natural daylight and/or direct sunlight is redirected into commercial or residential buildings or other terrestrial or maritime structures such as ships, trains, or aircrafts, and the amount of usable daylight in the structure may be increased when compared to conventional window openings, skylights, etc. In some embodiments, a secondary light source suitable for daylighting may include reflective surfaces which divert light from an incident angle towards a different area in the building and/or redirect light to pass through an opening, such as a window or skylight, which the light would otherwise not have passed through. The secondary light source may also include an OLED device in the lighting module which may emit light when there is little or no available daylight or sunlight.

An illustration of an embodiment using daylight as a primary light source and an OLED device with a reflective layer as a secondary light source is provided in FIG. 4. FIG. 4 is a perspective view of an interior space 98 having a window 100. The interior space 98 may refer to any enclosed space (e.g., livable space within a building, house, etc.). The window 100 may be a skylight window or any window positioned to let direct sunlight or diffuse daylight into the interior space 98. In some embodiments, the window 100 may include a secondary light source 44a arranged along a perimeter of window 100 or along one or more edges of the window 100. Similar to the embodiments described with respect to FIGS. 2 and 3, the secondary light source 44a may include an OLED device 52 configured to emit light and may also include one or more reflective layers and may be substantially mirror-like. Light rays from direct sunlight 102 or rays from diffuse daylight 104 that travel to the secondary light source 44a may be reflected as light rays 112 into the interior space. It should be noted that absent the mirror-like secondary light source 44a, impinging sunlight may be lost to absorption into a wall of the interior space. As such, the secondary light source 44a may increase light efficiency in the interior space 98 by directing sunlight or daylight into the interior space 98.

The secondary light source 44a may also emit light rays 110 into the interior space 98. In some embodiments, the secondary light source 44a may include control circuitry (e.g., control circuitry 60 from FIG. 3) that causes the secondary light source 44a to emit light rays 110. For example, the secondary light source 44a may emit light when activated (e.g., by a switch), or the secondary light source 44a may automatically power the OLED device in the secondary light source 44a when the reflected light rays 112 falls beneath a threshold intensity. In some embodiments, the threshold intensity may represent a light intensity level suitable for lighting an interior space, and when the reflected light rays 112 falls beneath the threshold intensity, the reflected light rays 112 may insufficiently light the interior space 98. In some embodiments, the control circuitry 60 may include an active system using sensors and/or actuators to move the module to track the sun for optimum interior daylighting. Alternatively, in some embodiments, the secondary light source 44a may be a passive system on a rigid non-moving mount. Furthermore, in one embodiment, the control circuitry 60 may be configured to monitor the amount of diffuse daylight or direct sunlight being reflected by the secondary light source 44a. If the amount of diffuse daylight or direct sunlight falls beneath the threshold intensity, the control circuitry 60 may power (e.g., via power supply 64 or through power leads) the secondary light source 44a, thereby activating the OLED device 52 in the secondary light source 44a.

The control circuitry 60 may further be suitable for determining an amount of light directed out of the secondary light source 44a as reflected light rays 112 and powering the OLED device 52 to emit light rays 110 to compensate for any insufficiency in the reflected light rays 112. For example, the control circuitry 60 may determine the intensity of the reflected light rays 112. As the intensity of the reflected light rays 112 gradually decreases (e.g., while the sun sets or as the sun moves), the control circuitry 60 may gradually increase the brightness of the emitted light rays 110 to compensate for the decrease of the reflected light rays 112. As such, the secondary light source 44a may reflect light rays 112 and emit light rays 110 concurrently such that a substantially consistent amount of light is directed into the interior space 98 at or above a threshold intensity.

Another embodiment of a secondary light source including an OLED device and a reflective layer is illustrated in FIG. 5. FIG. 5 is a perspective view of an interior space 98 having a window 120 which lets direct sunlight 102 and diffuse daylight 104 into the interior space 98 and an arrangement of secondary light sources 44b and 44c configured to increase the light efficiency of sunlight 102 and/or daylight 104 and configured to emit light 110 into the interior space 98.

In one embodiment, the secondary light source 44b may be arranged to be substantially perpendicularly with respect to the plane of the window 120. For example, the secondary light source 44b may be arranged horizontally with respect to a vertical pane of the window 120. The secondary light source 44b may be contained within a width of the window 120 (e.g., within the width of the window ledge) in some embodiments, or may extend beyond the width of the window 120 into the interior space 98. The secondary light source 44b may include one or more OLED devices 52. The secondary light source 44b may also include at least one reflective layer and may be substantially mirror-like. Diffuse daylight 104 or direct sunlight 102 which travel to the reflective surface of the secondary light source 44b may be reflected into the interior space 98.

In some embodiments, the reflective surface of the secondary light source 44b may be on the upper surface of the secondary light source 44b, such that diffuse daylight 104 or direct sunlight 102 which impinges the upper surface of the secondary light source 44b may be reflected upwards towards a ceiling of the interior space 98. The surface area of the secondary light source 44b may be curved or arced or flat in various embodiments to increase or maximize the amount of light rays reflected from the exterior environment 122 into the interior space 98. In some embodiments, the secondary light source 44b may also emit light 110 when activated, and may concurrently emit light 110 into the interior space 98 while reflecting light 112 into the interior space 98 and/or ceiling of the interior space 98. For example, the secondary light source 44b may reflect and/or emit an intensity of light which reaches or surpasses a threshold light intensity. In some embodiments, the secondary light source 44c may include an OLED device 52 and a reflective layer, and the secondary light source 44c may be substantially mirror-like. The light 112 reflected upwards by the secondary light source 44b may be reflected downwards towards in the interior space 98 by the secondary light source 44c.

In some embodiments, each or either of the secondary light sources 44b and/or 44c may include control circuitry (e.g., control circuitry 60 as in FIG. 3) which may determine the amount of light 112 that is reflected out of the secondary light source(s) 44b and/or 44c. The control circuitry 60 may also be configured to cause the secondary light source(s) 44b and/or 44c to emit light rays 110 based on the amount of light 112 that is reflected. For example, the secondary light source(s) 44b and/or 44c may emit an amount of light 110 such that the total amount of light reflected and/or emitted out of the light sources meets or surpasses a threshold light intensity.

Furthermore, in some embodiments, the reflective layers in the secondary light sources may be flat or curved or arced. In some embodiments, the secondary light sources 44b and/or 44c may be trough shaped and may have a parabolic cross section. The edges of the secondary light sources 44b and/or 44c may be straight or curved depending on functional, architectural, or aesthetic preferences. In various embodiments, the secondary light sources 44b and/or 44c may include a single OLED device 52 or multiple OLED devices 52 which are connected in series or in a parallel electrical string configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A light emitting module, comprising:
a reflective light source comprising one or more organic light emitting diode (OLED) devices, wherein the reflective light source is configured to reflect light from a different light source and configured to emit light based on the light reflected from the different light source.

2. The light emitting module of claim 1, wherein the reflective light source comprises a substrate, wherein one or more OLED devices are disposed on the substrate.

3. The light emitting module of claim 2, wherein the substrate comprises a reflective coating configured to have a reflectivity of approximately 70%.

4. The light emitting module of claim 2, wherein the substrate comprises one or more light extraction films.

5. The light emitting module of claim 4, wherein the one or more light extraction films comprises scattering particles.

6. The light emitting module of claim 2, wherein the substrate comprises one or more barrier layers.

7. The light emitting module of claim 6, wherein the one or more barrier layers comprises a graded structure oscillating between substantially organic zones and substantially inorganic zones.

8. The light emitting module of claim 1, wherein the one or more OLEDs in the reflective light source are bottom emissive OLEDs.

9. The light emitting module of claim 1, comprising control circuitry configured to detect when the different light source is powered but not emitting light.

10. The light emitting module of claim 9, wherein the reflective light source is configured to emit light when the different light source is not emitting light.

11. The light emitting module of claim 1, comprising control circuitry configured to detect when the different light source is not powered but is switched to an on state.

12. The light emitting module of claim 1, wherein the different light source comprises first power conductive structures configured for connection to a different power source and wherein the reflective light source comprises second power conductive structures configured for connection to a secondary power source.

13. The light emitting module of claim 1, comprising a secondary power supply and control circuitry configured to maintain a charge on the secondary power supply when the different light source is emitting light.

14. The light emitting module of claim 1, comprising a secondary power supply and control circuitry configured to power the reflective light source by supplying charge from the secondary power supply to the reflective light source.

15. The light emitting module of claim 1, comprising a light sensing element in communication with control circuitry, wherein the light sensing element is configured to detect whether the different light source is emitting light, and wherein the control circuitry is configured to power the reflective light source using a secondary power supply when the different light source is not emitting light.

16. The light emitting module of claim 1, wherein the different light source comprises direct sunlight, diffuse daylight, or combinations thereof, and wherein the reflective light source is configured to reflect portions of the direct sunlight, diffuse daylight, or combinations thereof as reflected light into an enclosed space.

17. The light emitting module of claim 16, comprising a control circuitry configured to determine an amount of light reflected into the enclosed space and configured to power the reflective light source such that the reflective light source emits light if the amount of reflected light falls beneath a threshold.

18. A lighting system comprising:
a primary light source configured to emit light when powered by a primary power supply;
control circuitry coupled to the primary light source, wherein the control circuitry determines whether the primary light source is powered;
a secondary light source coupled to the control circuitry, wherein the secondary light source comprises one or more organic light emitting diode (OLED) devices, and wherein the control circuitry is configured to power the secondary light source when the primary light source is determined to not be powered; and
a secondary power source coupled to the secondary light source, wherein the control circuitry is configured to power the secondary light source using the secondary power source.

19. The lighting system of claim 18, comprising a light sensing device in communication with the control circuitry, wherein the control circuitry is configured to determine whether the primary light source is powered based at least in part by an output of the light sensing device.

20. The lighting system of claim 18, wherein the control circuitry is configured to maintain a charge of the secondary power source using the primary power supply when the primary light source is powered.

21. The lighting system of claim 18, wherein the secondary power source comprises one or more capacitors or one or more batteries.

22. The lighting system of claim 18, wherein the secondary light source comprises a reflective coating facing the primary light source.

23. The lighting system of claim 18, wherein the secondary light source is configured in an angle or in an arc with respect to an axial direction of the primary light source.

24. A method of operating a light module, the method comprising:
monitoring a primary light source in the light module to determine whether the primary light source is emitting light and whether the primary light source is switched to an on state; and
activating a secondary light source in the light module when the primary light source is not emitting light while switched to the on state, wherein the secondary light source comprises one or more organic light emitting diode (OLED) devices.

25. The method of claim 24, comprising reflecting a portion of light emitted by the primary light source at the secondary light source.

26. The method of claim 24, wherein activating the secondary light source comprises powering the secondary light source using a secondary power supply separate from a first power supply used to power the primary light source.

27. The method of claim 24, comprising charging the secondary power supply when the primary light source is emitting light and switched to the on state.
